(19) United States
(12) Patent Application Publication
(10) Pub. No.: US 2022/0043365 A1
(43) Pub. Date: Feb. 10, 2022

(54) TONER, TONER CARTRIDGE, AND IMAGE FORMING APPARATUS

(71) Applicant: TOSHIBA TEC KABUSHIKI KAISHA, Tokyo (JP)

(72) Inventor: Takahiro NAKAJIMA, Kawasaki Kanagawa (JP)

(73) Assignee: TOSHIBA TEC KABUSHIKI KAISHA, Tokyo (JP)

(21) Appl. No.: 17/223,309

(22) Filed: Apr. 6, 2021

(30) Foreign Application Priority Data
Aug. 5, 2020 (JP) 2020-132980

(51) Int. Cl. G03G 9/087

(52) U.S. Cl. CPC G03G 9/08755; G03G 9/08797; G03G 9/08711; G03G 9/08782

(57) ABSTRACT

According to one embodiment, a toner having excellent heat resistance, storage stability, and fixability, and capable of suppressing occurrence of filming, and a toner cartridge and an image forming apparatus, in each of which the toner is stored, are provided. A toner according to an embodiment includes an amorphous polyester resin A having a softening point of 125 to 150° C., an amorphous polyester resin B having a softening point of 95 to 120° C., a crystalline polyester resin, and an ester wax.

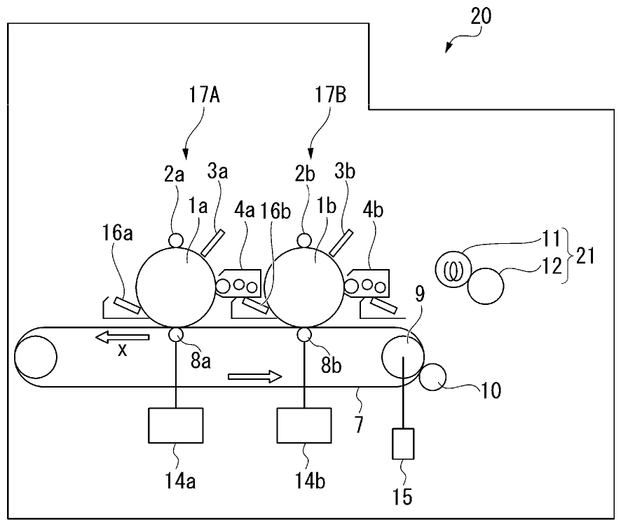

### CROSS-REFERENCE TO RELATED APPLICATION

This application is based upon and claims the benefit of priority from Japanese Patent Application No. 2020-132980, filed on Aug. 5, 2020 the entire contents of which are incorporated herein by reference.

### FIELD

Embodiments described herein relate generally to a toner, a toner cartridge, and an image forming apparatus.

### BACKGROUND

A toner containing a crystalline polyester resin (for example, Japanese Patent No. 3693327) is known. The toner containing a crystalline polyester resin has excellent low-temperature fixability. However, this toner containing a crystalline polyester resin has insufficient heat resistance and storage stability.

On the other hand, the use of an ester wax having excellent heat resistance is effective for improving the heat resistance and storage stability of a toner. However, the ester wax may seep out from the toner in a high temperature environment when forming an image. Therefore, the ester wax adheres in a film form to the surface of a photoconductor in an image forming apparatus, and filming may occur. When filming occurs, an image defect, such as a streak image, occurs when forming an image.

In addition, the toner is also required not to cause offset. That is the toner is required to have fixability even in a high temperature environment and also in a low temperature environment.

### DESCRIPTION OF THE DRAWING

The FIGURE is a diagram showing an example of a schematic structure of an image forming apparatus of an embodiment.

### DETAILED DESCRIPTION

An object to be achieved by the embodiments is to provide a toner having excellent heat resistance, storage stability, and fixability, and is capable of suppressing occurrence of filming. A toner cartridge and an image forming apparatus, in each of which the toner is stored, are also contemplated.

A toner according to an embodiment comprises an amorphous polyester resin A, an amorphous polyester resin B, a crystalline polyester resin, and an ester wax. The softening point of the amorphous polyester resin A is between 125 and 150° C. The softening point of the amorphous polyester resin B is between 95 and 120° C.

The ester wax is a condensation polymer of a first monomer group and a second monomer group. The first monomer group comprises at least three or more types of carboxylic acids. The second monomer group comprises at least three or more types of alcohols.

The proportion of a carboxylic acid with a carbon number of Cₙ is between 70 and 95 mass % with respect to 100 mass % of the first monomer group. The carbon number Cₙ is the carbon number of a carboxylic acid, the content of which is highest in the first monomer group. The proportion of a carboxylic acid with a carbon number of 18 or less in the first monomer group is 5 mass % or less with respect to 100 mass % of the first monomer group.

The proportion of an alcohol with a carbon number of Cₘ is between 70 and 90 mass % with respect to 100 mass % of the second monomer group. The carbon number Cₘ is the carbon number of an alcohol, the content of which is highest in the second monomer group. The proportion of an alcohol with a carbon number of 18 or less in the second monomer group is 20 mass % or less with respect to 100 mass % of the second monomer group.

The difference between the softening point of the amorphous polyester resin A and the softening point of the amorphous polyester resin B is between 20 and 45° C.

Hereinafter, the toner of the embodiment is described.

The toner of the embodiment comprises an amorphous polyester resin A, an amorphous polyester resin B, a crystalline polyester resin, and an ester wax.

The toner of the embodiment may further comprise a colorant.

The toner of the embodiment may further comprise another binder resin other than the amorphous polyester resin A, the amorphous polyester resin B, and the crystalline polyester resin as long as the effect disclosed in the embodiment is obtained.

The toner of the embodiment may further comprise another component other than the amorphous polyester resin A, the amorphous polyester resin B, the crystalline polyester resin, the ester wax, the colorant, and the another binder resin as long as the effect disclosed in the embodiment is obtained.

In any embodiment of the toner, a difference between the softening point of the amorphous polyester resin A and the softening point of the amorphous polyester resin B is between 20 and 45° C., preferably between 20 and 35° C., and more preferably between 20 and 30° C. Since the difference between the softening point of the amorphous polyester resin A and the softening point of the amorphous polyester resin B is the above lower limit or more, the dispersibility of the ester wax becomes moderately favorable, and offset is less likely to occur in a high temperature environment. Since the difference between the softening point of the amorphous polyester resin A and the softening point of the amorphous polyester resin B is the above upper limit or less, the dispersibility of the ester wax becomes favorable, and occurrence of filming is suppressed.

The amorphous polyester resin A is described.

The toner of the embodiment comprises the amorphous polyester resin A, and therefore, improves the heat resistance and fixability.

In any embodiment, a polyester resin in which the ratio of the softening temperature to the melting temperature (softening temperature/melting temperature) is less than 0.8 and more than 1.2 is defined as an “amorphous polyester resin”. Further, a polyester resin in which the ratio of the softening temperature to the melting temperature (softening temperature/melting temperature) is between 0.8 and 1.2 is defined as a “crystalline polyester resin”.

The softening point of the amorphous polyester resin A is between 125 and 150° C., preferably between 125 and 140° C., and more preferably between 125 and 135° C. Since the softening point of the amorphous polyester resin A is the above lower limit or higher, offset is less likely to occur in a high temperature environment. Further, the heat resistance of the toner is improved. Since the softening point of the amorphous polyester resin A is the above upper limit or lower, offset is less likely to occur in a low temperature environment.

The softening point of the amorphous polyester resin A can be measured by, for example, Constant Test Force Extrusion Type Capillary Rheometer (Flowtester).

The mass average molecular weight of the amorphous polyester resin A is preferably between 2.0×10⁴ and 9.0×10⁴, and more preferably between 2.8×10⁴ and 7.0×10⁴. When the mass average molecular weight of the amorphous polyester resin A is within the above range, the softening point of the amorphous polyester resin A tends to fall within the range from 125 to 150° C.

Further, when the mass average molecular weight of the amorphous polyester resin A is the above lower limit or more, the viscosity of the toner when fixing becomes high, and the low-temperature fixability is improved. When the mass average molecular weight of the amorphous polyester resin A is the above upper limit or less, the viscosity of the toner when fixing becomes low, and offset is less likely to occur.

The mass average molecular weight of the amorphous polyester resin A is a value in terms of polyethylene glycol measured by gel permeation chromatography.

An example of the amorphous polyester resin A includes a condensation polymer of a divalent or higher valent carboxylic acid and a dihydric or higher hydric alcohol.

Examples of the divalent or higher valent carboxylic acid include a divalent or higher valent carboxylic acid, an acid anhydride of a divalent or higher valent carboxylic acid, and an ester of a divalent or higher valent carboxylic acid. Examples of the ester of a divalent or higher valent carboxylic acid include a lower alkyl (having 1 to 12 carbon atoms) ester of a divalent or higher valent carboxylic acid.

Examples of the divalent carboxylic acid include maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, malonic acid, and succinic acid substituted with an alkyl group or an alkenyl group. However, the divalent carboxylic acid is not limited to these examples.

Examples of the succinic acid substituted with an alkyl group or an alkenyl group include succinic acid substituted with an alkyl group or an alkenyl group having 2 to 20 carbon atoms. For example, n-dodecenyl succinic acid, n-dodecyl succinic acid, and the like are contemplated. Further, an acid anhydride of the above-mentioned divalent carboxylic acid, or an ester of the above-mentioned divalent carboxylic acid may be used.

For the divalent carboxylic acid, maleic acid, fumaric acid, terephthalic acid, or succinic acid substituted with an alkenyl group having 2 to 20 carbon atoms is preferred.

For the divalent carboxylic acid, any one type may be used by itself or two or more types may be used in combination.

Examples of the trivalent or higher valent carboxylic acid include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra (methylenecarboxyl) methane, 1,2,7,8-octanetetracarboxylic acid, pyromellitic acid, enpol trimer acid, acid anhydrides thereof or esters thereof. However, the trivalent or higher valent carboxylic acid is not limited to these examples.

For the trivalent or higher valent carboxylic acid, 1,2,4-benzenetricarboxylic acid (trimellitic acid), an acid anhydride thereof, or a lower alkyl (having 1 to 12 carbon atoms) ester thereof is preferred.

For the trivalent or higher valent carboxylic acid, any one type may be used by itself or two or more types may be used in combination.

Examples of the dihydric alcohol include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A, hydrogenated bisphenol A, and an alkylene oxide adduct of bisphenol A. However, the dihydric alcohol is not limited to these examples.

Examples of the alkylene oxide adduct of bisphenol A include a compound obtained by adding 1 to 10 moles on the average of an alkylene oxide having 2 to 3 carbon atoms to bisphenol A. Examples of the alkylene oxide adduct of bisphenol A include polyoxypropylene (2.2) -2,2-bis (4-hydroxyphenyl) propane, polyoxypropylene (3.3) -2,2-bis (4-hydroxyphenyl) propane, polyoxyethylene (2.0) -2,2-bis (4-hydroxyphenyl) propane, polyoxypropylene (2.0) -polyoxyethylene (2.0) -2,2-bis (4-hydro xyphenyl)propane, and polyoxypropylene (6) -2,2-bis (4-hydroxyphenyl) propane.

For the dihydric alcohol, an alkylene oxide adduct of bisphenol A is preferred. For the dihydric alcohol, any one type may be used by itself or two or more types may be used in combination.

Examples of the trihydric or higher hydric alcohol include sorbitol, 1,2,3,6-hexatetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylol ethane, trimethylol propane, and 1,3,5-trihydroxymethylbenzene. However, the trihydric or higher hydric alcohol is not limited to these examples.

For the trihydric or higher hydric alcohol, sorbitol, 1,4-sorbitan, pentaerythritol, glycerol, or trimethylol propane is preferred.

For the trihydric or higher hydric alcohol, anyone type may be used by itself or two or more types may be used in combination.

When the dihydric or higher hydric alcohol and the divalent or higher valent carboxylic acid are subjected to polycondensation, a commonly used catalyst may be used for accelerating the reaction. Examples of the catalyst include dibutyltin oxide, a titanium compound, dialkoxytin(II), tin(II) oxide, fatty acid tin(II), tin(II) dioctanoate, and tin(II) distearate.

The amorphous polyester resin B is described.

In any embodiment, the toner comprises the amorphous polyester resin B in addition to the amorphous polyester resin A, and therefore, the dispersibility of the ester wax in the toner becomes favorable. Accordingly, occurrence of filming is suppressed.

The softening point of the amorphous polyester resin B is between 95 and 120° C., preferably between 98 and 115° C., and more preferably between 98 and 110° C. Since the softening point of the amorphous polyester resin B is the above lower limit or higher, offset is less likely to occur in a high temperature environment. Further, the heat resistance of the toner is improved. Since the softening point of the amorphous polyester resin B is the above upper limit or lower, offset is less likely to occur in a low temperature environment.

The softening point of the amorphous polyester resin B can be measured by, for example, Constant Test Force Extrusion Type Capillary Rheometer (Flowtester).

The mass average molecular weight of the amorphous polyester resin B is preferably between 6.0×10³ and 2.0×10⁴, and more preferably between 7.5×10³ and 1.5×10⁴. When the mass average molecular weight of the amorphous polyester resin B is within the above range, the softening point of the amorphous polyester resin B tends to fall within the range from 95 to 120° C.

Further, when the mass average molecular weight of the amorphous polyester resin B is the above lower limit or more, the viscosity of the toner when fixing becomes high, and the low-temperature fixability is improved. When the mass average molecular weight of the amorphous polyester resin B is the above upper limit or less, the viscosity of the toner when fixing becomes low, and offset is less likely to occur.

The mass average molecular weight of the amorphous polyester resin B is a value in terms of polyethylene glycol measured by gel permeation chromatography.

An example of the amorphous polyester resin B includes a condensation polymer of a divalent or higher valent carboxylic acid and a dihydric or higher hydric alcohol.

Examples of the divalent or higher valent carboxylic acid and the dihydric or higher hydric alcohol include the same ones as exemplified with respect to the amorphous polyester resin A. The divalent or higher valent carboxylic acid and the dihydric or higher hydric alcohol are selected from these divalent or higher valent carboxylic acids and dihydric or higher hydric alcohols so that the softening point falls within the range from 95 to 120° C.

The softening point of the amorphous polyester resin A and the softening point of the amorphous polyester resin B can be adjusted by, for example, selecting the types of the divalent or higher valent carboxylic acid and the dihydric or higher hydric alcohol, or changing the polymerization time.

The crystalline polyester resin is described.

The melting point of the crystalline polyester resin is preferably between 60 and 120° C., more preferably between 70 and 115° C., and further more preferably between 80 and 115° C. When the melting point of the crystalline polyester resin is the above lower limit or higher, the toner has more excellent heat resistance and storage stability. When the melting point of the crystalline polyester resin is the above upper limit or lower, the toner has excellent low-temperature fixability.

The melting point of the crystalline polyester resin can be measured by, for example, a differential scanning calorimeter (DSC).

The mass average molecular weight of the crystalline polyester resin is preferably between 6.0×10³ and 1.8×10⁴, and more preferably between 8.0×10³ and 1.4×10⁴. When the mass average molecular weight of the crystalline polyester resin is the above lower limit or more, the viscosity of the toner when fixing becomes high, and the low-temperature fixability is improved. When the mass average molecular weight of the crystalline polyester resin is the above upper limit or less, the viscosity of the toner when fixing becomes low, and offset is less likely to occur.

The mass average molecular weight of the crystalline polyester resin is a value in terms of polystyrene measured by gel permeation chromatography.

An example of the crystalline polyester resin includes a condensation polymer of a dihydric or higher hydric alcohol and a divalent or higher valent carboxylic acid.

Examples of the dihydric or higher hydric alcohol include ethylene glycol, 1,2-propylene glycol, 1,3-propylene glycol, 1,4-butanediol, 1,5-pentanediol, 1,6-hexanediol, neopentyl glycol, 1,4-butenediol, polyoxypropylene, polyoxyethylene, glycerin, pentaerythritol, and trimethylolpropane. However, the dihydric or higher hydric alcohol is not limited to these examples.

For the dihydric or higher hydric alcohol, 1,4-butanediol or 1,6-hexanediol is preferred.

For the dihydric or higher hydric alcohol, any one type may be used by itself or two or more types may be used in combination.

Examples of the divalent or higher valent carboxylic acid include adipic acid, oxalic acid, malonic acid, maleic acid, fumaric acid, citraconic acid, itaconic acid, glutaconic acid, succinic acid, phthalic acid, isophthalic acid, terephthalic acid, sebacic acid, azelaic acid, succinic acid substituted with an alkyl group or an alkenyl group, cyclohexane dicarboxylic acid, trimellitic acid, pyromellitic acid, and acid anhydrides thereof or esters thereof. However, the divalent or higher valent carboxylic acid is not limited to these examples.

Examples of the succinic acid substituted with an alkyl group or an alkenyl group include succinic acid substituted with an alkyl group or an alkenyl group having 2 to 20 carbon atoms. For example, n-dodecenyl succinic acid, n-dodecyl succinic acid, and the like are contemplated.

For the divalent or higher valent carboxylic acid, fumaric acid is preferred.

For the divalent or higher valent carboxylic acid, any one type may be used by itself or two or more types may be used in combination.

However, the crystalline polyester resin is not limited to the condensation polymer of a dihydric or higher hydric alcohol and a divalent or higher valent carboxylic acid exemplified here. For the crystalline polyester resin, any one type may be used by itself or two or more types may be used in combination.

The another binder resin is described.

Examples of the another binder resin include an amorphous polyester resin other than the amorphous polyester resin A and the amorphous polyester resin B, a styrenic resin, an ethylenic resin, an acrylic resin, a phenolic resin, an epoxy-based resin, an allyl phthalate-based resin, a polyamide-based resin, and a maleic acid-based resin. However, the another binder resin is not limited to these examples.

For the another binder resin, any one type may be used by itself or two or more types may be used in combination.

A styrenic resin, an ethylenic resin, an acrylic resin, a phenolic resin, an epoxy-based resin, an allyl phthalate-based resin, a polyamide-based resin, and a maleic acid-based resin is obtained by, for example, polymerizing a vinyl polymerizable monomer by itself or a plurality of types of vinyl polymerizable monomers.

Examples of the vinyl polymerizable monomer include an aromatic vinyl monomer, an ester-based monomer, a carboxylic acid-containing monomer, and an amine-based monomer.

Examples of the aromatic vinyl monomer include styrene, methylstyrene, methoxystyrene, phenylstyrene, chlorostyrene, and derivatives thereof.

Examples of the ester-based monomer include methyl acrylate, ethyl acrylate, butyl acrylate, methyl methacrylate, ethyl methacrylate, butyl methacrylate, and derivatives thereof.

Examples of the carboxylic acid-containing monomer include acrylic acid, methacrylic acid, fumaric acid, maleic acid, and derivatives thereof.

Examples of the amine-based monomer include amino acrylate, acrylamide, methacrylamide, vinylpyridine, vinylpyrrolidone, and derivatives thereof.

The another binder resin may be obtained by polycondensation of a polymerizable monomer component composed of an alcohol component and a carboxylic acid component. In the polycondensation of the polymerizable monomer component, various auxiliary agents such as a chain transfer agent, a crosslinking agent, a polymerization initiator, a surfactant, an aggregating agent, a pH adjusting agent, and an anti-foaming agent may be used.

The ester wax is described.

The ester wax of the embodiment comprises two or more types of ester compounds with a different carbon number.

In one embodiment, when the toner comprises the ester wax, the toner has excellent heat resistance and storage stability.

The ester wax of the embodiment is a condensation polymer of a first monomer group and a second monomer group.

The first monomer group is described.

The first monomer group comprises at least three or more types of carboxylic acids. The number of types of carboxylic acids in the first monomer group is preferably 7 types or less, and more preferably 5 types or less from the viewpoint that the ester wax is easy to obtain. Since the number of types of carboxylic acids in the first monomer group is the above lower limit or more, the toner has excellent heat resistance and storage stability.

Here, the carbon number of a carboxylic acid, the content of which is highest in the first monomer group, is denoted by Cₙ. The carbon number Cₙ is preferably between 19 and 28, more preferably between 19 and 24, and further more preferably between 20 and 24. When the carbon number Cₙ is the above lower limit or more, the heat resistance of the ester wax is improved. When the carbon number Cₙ is the above upper limit or less, the toner has excellent low-temperature fixability.

The proportion of the carboxylic acid with a carbon number of Cₙ, the content of which is highest, is between 70 and 95 mass %, preferably between 80 and 95 mass %, and more preferably between 85 and 95 mass % with respect to 100 mass % of the first monomer group. Since the proportion of the carboxylic acid with a carbon number of Cₙ is the above lower limit or more, the maximum peak of the carbon number distribution of the ester wax is located sufficiently on the high carbon number side. As a result, the toner has excellent heat resistance and storage stability. Since the proportion of the carboxylic acid with a carbon number of Cₙ is the above upper limit or less, the ester wax is easy to obtain.

The proportion of a carboxylic acid with a carbon number of 18 or less in the first monomer group is 5 mass % or less, preferably between 0 and 5 mass %, and more preferably between 0 and 1 mass % with respect to 100 mass % of the first monomer group. Since the proportion of the carboxylic acid with a carbon number of 18 or less is the above lower limit or more, the ester wax is easy to obtain. When the proportion of the carboxylic acid with a carbon number of 18 or less is the above upper limit or less, the proportion of an ester compound having a relatively low molecular weight in the ester wax becomes small. As a result, the toner has excellent heat resistance and storage stability.

The content of each of the carboxylic acids with the corresponding carbon number in the first monomer group can be measured by, for example, performing mass spectrometry using FD-MS (field desorption mass spectrometry) for a product after a methanolysis reaction of the ester wax. The total ionic strength of the carboxylic acids with the corresponding carbon number in the product obtained by the measurement using FD-MS is assumed to be 100. The relative value of the ionic strength of each of the carboxylic acids with the corresponding carbon number with respect to the total ionic strength is calculated. The calculated relative value is defined as the content of each of the carboxylic acids with the corresponding carbon number in the first monomer group. Further, the carbon number of the carboxylic acid with a carbon number, the relative value of which is highest, is denoted by Cₙ.

For the carboxylic acid in the first monomer group, a long-chain carboxylic acid is preferred from the viewpoint that the ester wax is easy to obtain, and a long-chain alkyl carboxylic acid is more preferred. The long-chain carboxylic acid is appropriately selected so that the ester wax meets the predetermined requirements.

The long-chain carboxylic acid is preferably a long-chain carboxylic acid with a carbon number of 19 to 28, and more preferably a long-chain carboxylic acid with a carbon number of 20 to 24. When the carbon number of the long-chain carboxylic acid is the above lower limit or more, the heat resistance of the ester wax is improved, and the toner has more excellent heat resistance and storage stability. When the carbon number of the long-chain carboxylic acid is the above upper limit or less, the toner has excellent low-temperature fixability.

Examples of the long-chain alkyl carboxylic acid include palmitic acid, stearic acid, arachidonic acid, behenic acid, lignoceric acid, cerotic acid, and montanic acid.

The second monomer group is described.

The second monomer group comprises at least three or more types of alcohols. The number of types of alcohols in the second monomer group is preferably 5 types or less from the viewpoint that the ester wax is easy to obtain. Since the number of types of alcohols in the second monomer group is the above lower limit or more, the toner has excellent heat resistance and storage stability.

Here, the carbon number of an alcohol, the content of which is highest in the second monomer group, is denoted by Cₘ. The carbon number Cₘ is preferably between 19 and 28, more preferably between 20 and 24, and further more preferably between 20 and 22. When the carbon number Cₘ is the above lower limit or more, the heat resistance of the ester wax is improved. When the carbon number Cₘ is the above upper limit or less, the toner has more excellent low-temperature fixability.

The proportion of the alcohol with a carbon number of Cₘ, the content of which is highest, is between 70 and 90 mass %, preferably between 80 and 90 mass %, and more preferably between 85 and 90 mass % with respect to 100 mass % of the second monomer group. Since the proportion of the alcohol with a carbon number of Cₘ is the above lower limit or more, the maximum peak of the carbon number distribution of the ester wax is located sufficiently on the high carbon number side. As a result, the toner has excellent heat resistance and storage stability. Since the proportion of the alcohol with a carbon number of Cₘ is the above upper limit or less, the ester wax is easy to obtain.

The proportion of an alcohol with a carbon number of 18 or less in the second monomer group is 20 mass % or less, preferably between 10 and 20 mass %, and more preferably between 15 and 20 mass % with respect to 100 mass % of the second monomer group. When the proportion of the alcohol with a carbon number of 18 or less is the above lower limit or more, the ester wax is easy to obtain. Since the proportion of the alcohol with a carbon number of 18 or less is the above upper limit or less, the proportion of an ester compound having a relatively low molecular weight in the ester wax becomes small. As a result, the toner has excellent heat resistance and storage stability.

The content of each of the alcohols with the corresponding carbon number in the second monomer group can be measured by, for example, performing mass spectrometry using FD-MS for a product after a methanolysis reaction of the ester wax. The total ionic strength of the alcohols with the corresponding carbon number in the product obtained by the measurement using FD-MS is assumed to be 100. The relative value of the ionic strength of each of the alcohols with the corresponding carbon number with respect to the total ionic strength is calculated. The calculated relative value is defined as the content of each of the alcohols with the corresponding carbon number in the second monomer group. Further, the carbon number of the alcohol with a carbon number, the relative value of which is highest, is denoted by Cₘ.

For the alcohol in the second monomer group, a long-chain alcohol is preferred from the viewpoint that the ester wax is easy to obtain, and a long-chain alkyl alcohol is more preferred. The long-chain alcohol is appropriately selected so that the ester wax meets the predetermined requirements. The long-chain alcohol is preferably a long-chain alcohol with a carbon number of 19 to 28, and more preferably a long-chain alcohol with a carbon number of 20 to 22. When the carbon number of the long-chain alcohol is the above lower limit or more, the heat resistance of the ester wax is improved, and the toner has more excellent heat resistance and storage stability. When the carbon number of the long-chain alcohol is the above upper limit or less, the toner has excellent low-temperature fixability.

Examples of the long-chain alkyl alcohol include palmityl alcohol, stearyl alcohol, arachidyl alcohol, behenyl alcohol, lignoceryl alcohol, ceryl alcohol, and montanyl alcohol.

In any embodiment, the ester wax comprises an ester compound with a carbon number of C₁, wherein the content of which is highest among the ester compounds constituting the ester wax of the embodiment, is preferably present. The carbon number C₁ is preferably 43 or more, more preferably between 43 and 56, further more preferably between 43 and 52, particularly preferably between 44 and 46, and most preferably 44. When the carbon number C₁ is the above lower limit or more, the toner has more excellent heat resistance and storage stability. When the carbon number C₁ is the above upper limit or less, the ester wax is easy to obtain.

The ester compound with a carbon number of C₁ is represented by the following formula (I).

R¹COOR² (I)

In the formula (I), R¹ and R² are each an alkyl group. The total carbon number of R¹ and R² is preferably 42 or more, more preferably between 42 and 55, further more preferably between 42 and 51, particularly preferably between 43 and 45, and most preferably 43. When the total carbon number of R¹ and R² is the above lower limit or more, the toner has more excellent heat resistance and storage stability. When the total carbon number of R¹ and R² is the above upper limit or less, the ester wax is easy to obtain. The carbon number of R¹ can be controlled by adjusting the carbon number Cₙ of the below-mentioned carboxylic acid with a carbon number of Cₙ. The carbon number of R² can be controlled by adjusting the carbon number Cₘ of the below-mentioned alcohol with a carbon number of Cₘ.

The proportion of the ester compound with a carbon number of C₁ is preferably 65 mass % or more, more preferably between 65 and 90 mass %, further more preferably between 70 and 90 mass %, and particularly preferably between 80 and 90 mass % with respect to 100 mass % of the ester wax. When the proportion of the ester compound with a carbon number of C₁ is the above lower limit or more, the maximum peak of the carbon number distribution of the ester wax becomes sufficiently high. As a result, the toner has more excellent heat resistance and storage stability.

When the proportion of the ester compound with a carbon number of C₁ is the above upper limit or less, the ester wax is easy to obtain.

The carbon number distribution of the ester wax of the embodiment preferably has only one maximum peak in a region where the carbon number is 43 or more. In that case, the proportion of an ester compound having a relatively low molecular weight becomes small. As a result, the toner has more excellent heat resistance and storage stability.

In the carbon number distribution of the ester wax of the embodiment, the position of the maximum peak is preferably in a region where the carbon number is between 43 and 56, more preferably in a region where the carbon number is between 44 and 52, further more preferably in a region where the carbon number is between 44 and 46, and most preferably a position where the carbon number is 44. When the position of the maximum peak is in a region where the carbon number is the above lower limit or more, the toner has more excellent heat resistance and storage stability. When the position of the maximum peak is in a region where the carbon number is the above upper limit or less, the ester wax is easy to obtain.

The content of each of the ester compounds with the corresponding carbon number in the ester wax can be measured by, for example, mass spectrometry using FD-MS. The total ionic strength of the ester compounds with the corresponding carbon number in the ester wax obtained by the measurement using FD-MS is assumed to be 100. The relative value of the ionic strength of each of the ester compounds with the corresponding carbon number with respect to the total ionic strength is calculated. The calculated relative value is defined as the content of each of the ester compounds with the corresponding carbon number in the ester wax. Further, the carbon number of the ester compound with a carbon number, the relative value of which is highest, is denoted by Cₗ.

The melting point of the ester wax is preferably between 60 and 85° C., more preferably between 65 and 80° C., and further more preferably between 65 and 75° C. When the melting point of the ester wax is the above lower limit or higher, the toner has more excellent heat resistance and storage stability. Further, offset is less likely to occur in a high temperature environment. When the melting point of the ester wax is the above upper limit or lower, the toner has excellent low-temperature fixability.

The melting point of the ester wax can be measured by, for example, differential scanning calorimetry (DSC).

The difference between the melting point of the ester wax and the softening point of the amorphous polyester resin A is preferably between 40 and 90° C., more preferably between 45 and 75° C., and further more preferably between 50 and 70° C. When the difference between the melting point of the ester wax and the softening point of the amorphous polyester resin A is the above lower limit or more, the dispersibility of the ester wax becomes moderately favorable, and offset is less likely to occur in a high temperature environment. When the difference between the melting point of the ester wax and the softening point of the amorphous polyester resin A is the above upper limit or less, the dispersibility of the ester wax tends to become favorable. As a result, occurrence of filming is more sufficiently suppressed.

The difference between the melting point of the ester wax and the softening point of the amorphous polyester resin B is preferably between 10 and 60° C., more preferably between 20 and 50° C., and further more preferably between 25 and 45° C. When the difference between the melting point of the ester wax and the softening point of the amorphous polyester resin B is the above lower limit or more, the dispersibility of the ester wax becomes moderately favorable, and offset is less likely to occur in a high temperature environment. When the difference between the melting point of the ester wax and the softening point of the amorphous polyester resin B is the above upper limit or less, the dispersibility of the ester wax tends to become favorable. As a result, occurrence of filming is more sufficiently suppressed.

A method for preparing the ester wax is described.

The ester wax can be prepared by, for example, subjecting a long-chain carboxylic acid and a long-chain alcohol to an esterification reaction. In the esterification reaction, at least three or more types of long-chain alkyl carboxylic acids and at least three or more types of long-chain alkyl alcohols are preferably used from the viewpoint that the ester wax that meets the predetermined requirements is easily obtained. When the used amount of each of the at least three types of long-chain alkyl carboxylic acids and the at least three types of long-chain alkyl alcohols is adjusted, the carbon number distribution of the ester compounds contained in the ester wax can be adjusted. The esterification reaction is preferably performed while heating under a nitrogen gas stream.

The esterification reaction product may be purified by being dissolved in a solvent containing ethanol, toluene, or the like, and further adding a basic aqueous solution such as a sodium hydroxide aqueous solution to separate the solution into an organic layer and an aqueous layer. By removing the aqueous layer, the ester wax can be obtained. The purification operation is preferably repeated a plurality of times.

The colorant is described.

The colorant is not particularly limited. Examples thereof include carbon black, cyan, yellow, and magenta-based pigments and dyes.

Examples of the carbon black include aniline black, lamp black, acetylene black, furnace black, thermal black, channel black, and Ketjen black.

Examples of the pigments and dyes include Fast Yellow G, benzidine yellow, chrome yellow, quinoline yellow, Indofast Orange, Irgazin Red, Carmine FB, Permanent Bordeaux FRR, Pigment Orange R, Lithol Red 2G, Lake Red C, Rhodamine FB, Rhodamine B Lake, Du Pont Oil Red, phthalocyanine blue, Pigment Blue, aniline blue, calcoil blue, ultramarine blue, brilliant green B, phthalocyanine green, malachite green oxalate, methylene blue chloride, rose bengal, and quinacridone.

Examples of the colorant include C.I. Pigment Black 1, 6, and 7, C.I. Pigment Yellow 1, 12, 14, 17, 34, 74, 83, 97, 155, 180, and 185, C.I. Pigment Orange 48 and 49, C.I. Pigment Red 5, 12, 31, 48, 48:1, 48:2, 48:3, 48:4, 48:5, 49, 53, 53:1, 53:2, 53:3, 57, 57:1, 81, 81:4, 122, 146, 150, 177, 185, 202, 206, 207, 209, 238, and 269, C.I. Pigment Blue 15, 15:1, 15:2, 15:3, 15:4, 15:5, 15:6, 75, 76, and 79, C.I. Pigment Green 1, 7, 8, 36, 42, and 58, C.I. Pigment Violet 1, 19, and 42, and C.I. Acid Red 52, each of which is indicated by the Color Index Number. However, the colorant is not limited to these examples.

For the colorant, any one type may be used by itself or two or more types may be used in combination.

The another component is described.

Examples of the another component include additives such as a charge control agent, a surfactant, a basic compound, an aggregating agent, a pH adjusting agent, and an antioxidant. However, the another component is not limited to these examples. As the additive, any one type may be used by itself or two or more types may be used in combination.

The charge control agent is described.

When the toner comprises a charge control agent, the toner is easily transferred onto a recording medium such as paper. Examples of the charge control agent include a metal-containing azo compound, a metal-containing salicylic acid derivative compound, a hydrophobized metal oxide, and a polysaccharide inclusion compound. For the metal-containing azo compound, a complex or a complex salt in which the metal is iron, cobalt, or chromium, or a mixture thereof is preferred. For the metal-containing salicylic acid derivative compound and the hydrophobized metal oxide, a complex or a complex salt in which the metal is zirconium, zinc, chromium, or boron, or a mixture thereof is preferred. For the polysaccharide inclusion compound, a polysaccharide inclusion compound containing aluminum (Al) and magnesium (Mg) is preferred.

An external additive is described.

The toner of the embodiment may include an external additive as needed. In that case, the external additive is attached to surfaces of the toner base particles. The toner base particles comprise at least the amorphous polyester resin A, the amorphous polyester resin B, the crystalline polyester resin, and the ester wax.

Examples of the external additive include particles composed of an inorganic oxide. Examples of the inorganic oxide include silica, titania, alumina, strontium titanate, titanium oxide, and tin oxide. Further, the particles composed of the inorganic oxide may be subjected to a surface treatment with a hydrophobizing agent from the viewpoint of improvement of stability. As the external additive, any one type may be used by itself or two or more types may be used in combination.

The external additive preferably comprises silica particles from the viewpoint that the electric charge amount of the toner is sufficiently maintained.

For the silica particles, wet silica is preferred from the viewpoint that the electric charge amount of the toner is more sufficiently maintained. The wet silica can be produced by, for example, a method (liquid phase method) in which sodium silicate made from silica sand is used as a raw material, and an aqueous solution containing sodium silicate is neutralized to deposit silica, and the silica is filtered and dried. On the other hand, fumed silica (dry silica) obtained by reacting silicon tetrachloride in a flame at high temperature is known. When wet silica is used as the external additive of the toner, the electric charge amount of the toner is generally easily maintained as compared with fumed silica having a low moisture content.

For the silica particles, hydrophobic silica particles are preferred from the viewpoint that the toner has more excellent heat resistance. The hydrophobic silica particles are obtained by, for example, hydrophobizing a surface silanol group of wet silica with silane, silicone, or the like. When the hydrophobic silica particles are used as the external additive of the toner, the adhesiveness thereof to the toner base particles is enhanced.

The composition of the toner is described.

The content of the amorphous polyester resin A is preferably between 5 and 40 mass %, more preferably between 10 and 25 mass %, and further more preferably between 10 and 20 mass % with respect to 100 mass % of the toner base particles. When the content of the amorphous polyester resin A is the above lower limit or more, offset is much less likely to occur in a high temperature environment. Further, the toner has more excellent heat resistance. When the content of the amorphous polyester resin A is the above upper limit or less, offset is much less likely to occur in a low temperature environment.

The content of the amorphous polyester resin B is preferably between 40 and 70 mass %, more preferably between 50 and 65 mass %, and further more preferably between 55 and 65 mass % with respect to 100 mass % of the toner base particles. When the content of the amorphous polyester resin B is the above lower limit or more, offset is much less likely to occur in a low temperature environment. When the content of the amorphous polyester resin B is the above upper limit or less, offset is much less likely to occur in a high temperature environment.

The mass ratio of the content of the amorphous polyester resin B to the content of the amorphous polyester resin A is preferably between 1/9 and 5/5, more preferably between 1/9 and 3/7, and particularly preferably between 15/85 and 25/75. When the mass ratio is the above lower limit or more, offset is much less likely to occur in a low temperature environment. Further, the dispersibility of the ester wax is further improved, and occurrence of filming is more sufficiently suppressed. When the mass ratio is the above upper limit or less, the dispersibility of the ester wax becomes moderately favorable, and offset is much less likely to occur in a high temperature environment.

The content of the crystalline polyester resin is preferably between 5 and 25 mass %, more preferably between 5 and 20 mass %, and furthermore preferably between 5 and 15 mass % with respect to 100 mass % of the toner base particles. When the content of the crystalline polyester resin is the above lower limit or more, the toner has excellent low-temperature fixability. When the content of the crystalline polyester resin is the above upper limit or less, the toner has more excellent heat resistance and storage stability.

The content of the ester wax is preferably between 3 and 15 mass %, more preferably between 3 and 13 mass %, and further more preferably between 5 and 10 mass % with respect to 100 mass % of the toner base particles. When the content of the ester wax is the above lower limit or more, the toner has more excellent heat resistance and storage stability. When the content of the ester wax is the above upper limit or less, the toner has excellent low-temperature fixability.

When the toner contains a colorant, the content of the colorant is preferably between 2 and 13 mass %, and more preferably between 3 and 8 mass % with respect to 100 mass % of the toner. When the content of the colorant is the above lower limit or more, the toner has excellent color reproducibility. When the content of the colorant is the above upper limit or less, the dispersibility of the colorant is excellent, and the toner has excellent low-temperature fixability.

When the toner contains an external additive, the content of the external additive is preferably between 2 and 15 parts by mass, more preferably between 4 and 10 parts by mass, and further more preferably between 4 and 8 parts by mass with respect to 100 parts by mass of the toner base particles. When the content of the external additive is the above lower limit or more, the electric charge amount of the toner is easily ensured. When the content of the external additive is the above upper limit or less, the electric charge amount of the toner is less likely to become excessively large. Therefore, the electric charge amount of the toner is easily moderately maintained.

A method for producing a toner is described.

The toner base particles can be produced by, for example, a kneading and pulverization method or a chemical method.

The toner base particles can be directly used as a toner. When the toner including an external additive is produced, the toner base particles and the external additive are mixed.

The kneading and pulverization method will be descried.

As the kneading and pulverization method, for example, a production method including the following mixing step, kneading step, and pulverization step is exemplified. The kneading and pulverization method may further include the following classification step as needed.
Mixing step: a step of mixing at least the amorphous polyester resin A, the amorphous polyester resin B, the crystalline polyester resin, and the ester wax, thereby obtaining a mixture
Kneading step: a step of melt-kneading the mixture, thereby obtaining a kneaded material
Pulverization step: a step of pulverizing the kneaded material, thereby obtaining a pulverized material
Classification step: a step of classifying the pulverized material

In the mixing step, the raw materials of the toner are mixed, thereby obtaining a mixture. In the mixing step, a mixer may be used. The mixer is not particularly limited. In the mixing step, a colorant, another binder resin, or an additive may be used as needed.

In the kneading step, the mixture obtained in the mixing step is melt-kneaded, thereby obtaining a kneaded material. In the kneading step, a kneader may be used. The kneader is not particularly limited.

In the pulverization step, the kneaded material obtained in the kneading step is pulverized, thereby obtaining a pulverized material. In the pulverization step, a pulverizer may be used. As the pulverizer, various pulverizers such as a hammer mill can be used. Further, the pulverized material obtained by the pulverizer may be further finely pulverized. As a pulverizer that further finely pulverizes the pulverized material, various pulverizers can be used. The pulverized material obtained in the pulverization step may be directly used as the toner base particles, or may be subjected to the classification step as needed and used as the toner base particles.

In the classification step, the pulverized material obtained in the pulverization step is classified. In the classification step, a classifier may be used. The classifier is not particularly limited.

The chemical method is described.

In the chemical method, the amorphous polyester resin A, the amorphous polyester resin B, the crystalline polyester resin, the ester wax, and according to need, a colorant, another binder resin, or an additive are mixed, thereby obtaining a mixture. Subsequently, the mixture is melt-kneaded, thereby obtaining a kneaded material. Subsequently, the kneaded material is pulverized, thereby obtaining coarsely granulated moderately pulverized particles. Subsequently, the moderately pulverized particles are mixed with an aqueous medium, thereby preparing a mixed liquid. Subsequently, the mixed liquid is subjected to mechanical shearing, thereby obtaining a fine particle dispersion liquid. Finally, fine particles are aggregated in the fine particle dispersion liquid, thereby forming toner base particles.

A method for mixing the external additive will be described.

The external additive is mixed with the toner base particles using, for example, a mixer. The mixer is not particularly limited. By mixing the external additive with the toner base particles, the external additive is attached to surfaces of the toner base particles.

The external additive may be sieved using a sieving device as needed. The sieving device is not particularly limited. Various sieving devices can be used.

An embodiment of the toner cartridge is described.

In any embodiment of the toner cartridge, the toner of the embodiment described above is stored. For example, the toner cartridge includes a container, and the toner of the embodiment is stored in the container. The container is not particularly limited, and various containers that can be applied to an image forming apparatus can be used.

The toner of the embodiment may be used as a one-component developer or may be combined with a carrier and used as a two-component developer.

Hereinafter, an image forming apparatus of an embodiment is described with reference to the drawing.

The FIGURE is a diagram showing an example of a schematic structure of the image forming apparatus of the embodiment.

An image forming apparatus 20 of the embodiment has an apparatus body including an intermediate transfer belt 7, and a first image forming unit 17A and a second image forming unit 17B provided in this order on the intermediate transfer belt 7, and a fixing device 21 provided downstream thereof. Along the running direction X of the intermediate transfer belt 7, that is, along the progress direction of the image forming process, the first image forming unit 17A is provided downstream of the second image forming unit 17B. The fixing device 21 is provided downstream of the first image forming unit 17A.

The first image forming unit 17A includes a photoconductive drum 1a, a cleaning device 16a, an electrostatic charging device 2a, a light exposure device 3a, a first developing device 4a, and a primary transfer roller 8a. The cleaning device 16a, the electrostatic charging device 2a, the light exposure device 3a, and the first developing device 4a are provided in this order along the rotational direction of the photoconductive drum 1a. The primary transfer roller 8a is provided on the photoconductive drum 1a through the intermediate transfer belt 7 so as to face the photoconductive drum 1a. To the primary transfer roller 8a, a primary transfer power supply 14a is connected.

The second image forming unit 17B includes a photoconductive drum 1b, a cleaning device 16b, an electrostatic charging device 2b, a light exposure device 3b, a second developing device 4b, and a primary transfer roller 8b. The cleaning device 16b, the electrostatic charging device 2b, the light exposure device 3b, and the second developing device 4b are provided in this order along the rotational direction of the photoconductive drum 1b. The primary transfer roller 8b is provided on the photoconductive drum 1b through the intermediate transfer belt 7 so as to face the photoconductive drum 1b. To the primary transfer roller 8b, a primary transfer power supply 14b is connected.

In the first developing device 4a and in the second developing device 4b, the toner of the embodiment described above is stored. In an image forming apparatus according to another embodiment, the toner may be supplied from a toner cartridge (not shown).

Downstream of the first image forming unit 17A, a secondary transfer roller 9 and a backup roller 10 are disposed so as to face each other through the intermediate transfer belt 7. To the secondary transfer roller 9, a secondary transfer power supply 15 is connected.

The fixing device 21 is provided downstream of the first image forming unit 17A. The fixing device 21 includes a heat roller 11 and a press roller 12 disposed so as to face each other. The fixing device 21 is a device for fixing the toner to a recording medium. A toner image is fixed to paper by heating and pressing using the heat roller 11 and the press roller 12.

By the image forming apparatus 20, image formation is performed, for example, as follows.

First, by the electrostatic charging device 2b, the photoconductive drum 1b is uniformly charged. Subsequently, by the light exposure device 3b, light exposure is performed, whereby an electrostatic latent image is formed. Subsequently, the electrostatic latent image is developed using the toner of the embodiment supplied from the developing device 4b, whereby a second toner image is obtained.

Subsequently, by the electrostatic charging device 2a, the photoconductive drum 1a is uniformly charged. Subsequently, by the light exposure device 3a, light exposure is performed based on the first image information (second toner image), whereby an electrostatic latent image is formed. Subsequently, the electrostatic latent image is developed using the toner of the embodiment supplied from the developing device 4a, whereby a first toner image is obtained.

The second toner image and the first toner image are transferred in this order onto the intermediate transfer belt 7 using the primary transfer rollers 8a and 8b.

An image in which the second toner image and the first toner image are stacked in this order on the intermediate transfer belt 7 is secondarily transferred onto a recording medium (not shown) through the secondary transfer roller 9 and the backup roller 10. By doing this, an image in which the first toner image and the second toner image are stacked in this order is formed on the recording medium.

The image forming apparatus shown in the FIGURE is configured to fix a toner image. However, the image forming apparatus of the embodiment is not limited to this configuration. An image forming apparatus according to another embodiment may be, for example, configured to use an inkjet system.

The toner of at least one embodiment described above has excellent heat resistance, storage stability, and fixability, and can suppress occurrence of filming.

### Examples

Hereinafter, embodiments are more specifically described by showing Examples.

The amorphous polyester resins A used in the respective Examples are as follows.
amorphous polyester resin A1 (softening point: 132° C., mass average molecular weight: 4.5×10⁴)
amorphous polyester resin A2 (softening point: 141° C., mass average molecular weight: 3.2×10⁴)
amorphous polyester resin A3 (softening point: 125° C., mass average molecular weight: 8.8×10⁴)
amorphous polyester resin A4 (softening point: 150° C., mass average molecular weight: 2.0×10⁴)
amorphous polyester resin A5 (softening point: 140° C., mass average molecular weight: 3.2×10⁴)
amorphous polyester resin A6 (softening point: 121° C., mass average molecular weight: 9.4×10⁴)
amorphous polyester resin A7 (softening point: 153° C., mass average molecular weight: 1.8×10⁴)
amorphous polyester resin A8 (softening point: 128° C., mass average molecular weight: 8.3×10⁴)
amorphous polyester resin A9 (softening point: 146° C., mass average molecular weight: 2.9×10⁴)

The amorphous polyester resins B used in the respective Examples are as follows.
amorphous polyester resin B1 (softening point: 103° C., mass average molecular weight: 1.2×10⁴)
amorphous polyester resin B2 (softening point: 95° C., mass average molecular weight: 7.5×10³)
amorphous polyester resin B3 (softening point: 120° C., mass average molecular weight: 1.9×10⁴)
amorphous polyester resin B4 (softening point: 105° C., mass average molecular weight: 1.2×10⁴)
amorphous polyester resin B5 (softening point: 92° C., mass average molecular weight: 7.0×10³)
amorphous polyester resin B6 (softening point: 122° C., mass average molecular weight: 2.0×10⁴)
amorphous polyester resin B7 (softening point: 110° C., mass average molecular weight: 1.5×10⁴)
amorphous polyester resin B8 (softening point: 98° C., mass average molecular weight: 9.5×10³)

A measurement method for the softening point of the amorphous polyester resin A and the softening point of the amorphous polyester resin B will be described.

1.0 g of each of the toners of the respective Examples was molded into a pellet form by a compression machine. With respect to the toner in a pellet form, the softening point of the amorphous polyester resin A and the softening point of the amorphous polyester resin B were measured using a flow tester (product name: CFT-500D (manufactured by Shimadzu Corporation)). The measurement conditions are as follows.

Measurement start temperature: 30° C.

Measurement end temperature: 200° C.

Load: 10 kgf

Temperature raising rate: 2.5° C./min

Residual heat time: 300 sec

A measurement method for the melting point of the ester wax and the melting point of the crystalline polyester resin will be described.

The melting point of the ester wax was measured by a DSC “DSC Q2000 (manufactured by TA Instruments, Inc.)”. The measurement conditions are as follows.

Sample amount: 5 mg

Lid and pan: alumina

Temperature raising rate: 10° C./min

Measurement method: The temperature of a sample is raised from 20° C. to 200° C. Thereafter, the sample is cooled to 20° C. or lower. The sample is heated again, and the maximum endothermic peak measured in a temperature range from 55 to around 80° C. is defined as the melting point of the ester wax.

The melting point of the crystalline polyester resin described below is also measured in the same manner as described above. However, the maximum endothermic peak measured in a temperature range from 75 to around 120° C. when heating the sample again is defined as the melting point of the crystalline polyester resin.

The crystalline polyester resin used in the respective Examples is as follows.
crystalline polyester resin (melting point: 94° C., mass average molecular weight: 9.5×10³)

Preparation of ester waxes A to O used in the respective Examples is described.

Into a four-neck flask equipped with a stirrer, a thermocouple, and a nitrogen introduction tube, 80 parts by mass of at least three or more types of long-chain alkyl carboxylic acids and 20 parts by mass of at least three or more types of long-chain alkyl alcohols were placed. An esterification reaction was performed at 220° C. under a nitrogen gas stream, whereby a reaction product was obtained. To the obtained reaction product, a mixed solvent of toluene and ethanol was added, thereby dissolving the reaction product. Further, a sodium hydroxide aqueous solution was added to the flask, and the resultant was stirred at 70° C. for 30 minutes. Further, the flask was left to stand for 30 minutes to separate the contents of the flask into an organic layer and an aqueous layer, and then, the aqueous layer was removed from the contents. Thereafter, ion exchanged water was added to the flask, and the resultant was stirred at 70° C. for 30 minutes. The flask was left to stand for 30 minutes to separate the contents of the flask into an aqueous layer and an organic layer, and then, the aqueous layer was removed from the contents. This operation was repeated five times. The solvent was distilled off from the organic layer in the contents of the flask under a reduced pressure condition, whereby an ester wax A was obtained.

Ester waxes B to O were obtained in the same manner as the ester wax A except that the types of the used long-chain alkyl carboxylic acids and long-chain alkyl alcohols, and the used amounts thereof were changed.

The long-chain alkyl carboxylic acids used in the respective Examples are as follows.
Palmitic acid (C₁₆H₃₂O₂)
Stearic acid (C₁₈H₃₆O₂)
Arachidonic acid (C₂₀H₄₀O₂)
Behenic acid (C₂₂H₄₄O₂)
Lignoceric acid (C₂₄H₄₈O₂)
Cerotic acid (C₂₆H₅₂O₂)
Montanic acid (C₂₈H₅₆O₂)

The long-chain alkyl alcohols used in the respective Examples are as follows.
Palmityl alcohol (C₁₆H₃₄O)
Stearyl alcohol (C₁₈H₃₈O)
Arachidyl alcohol (C₂₀H₄₂O)
Behenyl alcohol (C₂₂H₄₆O)
Lignoceryl alcohol (C₂₄H₅₀O)
Ceryl alcohol (C₂₆H₅₄O)
Montanyl alcohol (C₂₈H₅₈O)

A toner of Example 1 was produced as follows.

First, the raw materials of toner base particles were placed in a Henschel mixer (manufactured by Mitsui Mining Co.; Ltd.) and mixed. Further, the mixture of the raw materials of the toner base particles was melt-kneaded using a twin-screw extruder. The resulting melt-kneaded material was cooled, and then, coarsely pulverized using a hammer mill. The coarsely pulverized material was finely pulverized using a jet pulverizer. The finely pulverized material was classified, whereby the toner base particles were obtained.

The composition of the raw materials of the toner base particles is shown below.

| | | |
|---|---|---|
| Crystalline polyester resin | 10 | parts by mass |
| Amorphous polyester resin A1 | 15 | parts by mass |
| Amorphous polyester resin B1 | 63 | parts by mass |
| Ester wax A | 5 | parts by mass |
| Carbon black | 6 | parts by mass |
| Charge control agent (polysaccharide | 1 | part by mass |
| inclusion compound containing Al and Mg) | | |

Subsequently, an external additive was mixed with the toner base particles using a Henschel mixer, whereby the toner of Example 1 was produced. The external additive was used according to the composition shown below with respect to 100 parts by mass of the toner base particles.

| | | |
|---|---|---|
| Silica particles A (particle diameter: 50 nm) | 1 | part by mass |
| Silica particles B (particle diameter: 40 nm) | 2 | parts by mass |
| Silica particles C (particle diameter: 100 nm) | 0.8 | parts by mass |
| Hydrophobic strontium titanate (D₅₀: 20 nm) | 1 | part by mass |

Here, the volume average primary particle diameter: D₅₀ was measured using a laser diffraction particle size distribution analyzer (manufactured by Shimadzu Corporation (SALD-7000)).

A toner of Example 2 was produced as follows.

The toner of Example 2 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A2 | 15 | parts by mass |
| Amorphous polyester resin B1 | 63 | parts by mass |
| Ester wax A | 5 | parts by mass |
| Carbon black | 6 | parts by mass |
| Charge control agent (polysaccharide | 1 | part by mass |
| inclusion compound containing Al and Mg) | | |

A toner of Example 3 was produced as follows.

The toner of Example 3 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A3 | 15 | parts by mass |
| Amorphous polyester resin B2 | 63 | parts by mass |
| Ester wax A | 5 | parts by mass |
| Carbon black | 6 | parts by mass |
| Charge control agent (polysaccharide | 1 | part by mass |
| inclusion compound containing Al and Mg) | | |

A toner of Example 4 was produced as follows.

The toner of Example 4 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A4 | 15 | parts by mass |
| Amorphous polyester resin B3 | 63 | parts by mass |
| Ester wax A | 5 | parts by mass |
| Carbon black | 6 | parts by mass |
| Charge control agent (polysaccharide | 1 | part by mass |
| inclusion compound containing Al and Mg) | | |

A toner of Example 5 was produced as follows.

The toner of Example 5 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A4 | 15 | parts by mass |
| Amorphous polyester resin B4 | 63 | parts by mass |
| Ester wax A | 5 | parts by mass |
| Carbon black | 6 | parts by mass |
| Charge control agent (polysaccharide | 1 | part by mass |
| inclusion compound containing Al and Mg) | | |

A toner of Example 6 was produced as follows.

The toner of Example 6 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A3 | 15 | parts by mass |
| Amorphous polyester resin B4 | 63 | parts by mass |
| Ester wax A | 5 | parts by mass |
| Carbon black | 6 | parts by mass |
| Charge control agent (polysaccharide | 1 | part by mass |
| inclusion compound containing Al and Mg) | | |

A toner of Example 7 was produced as follows.

The toner of Example 7 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A5 | 15 | parts by mass |
| Amorphous polyester resin B2 | 63 | parts by mass |
| Ester wax A | 5 | parts by mass |
| Carbon black | 6 | parts by mass |
| Charge control agent (polysaccharide | 1 | part by mass |
| inclusion compound containing Al and Mg) | | |

A toner of Example 8 was produced as follows.

The toner of Example 8 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A3 | 15 | parts by mass |
| Amorphous polyester resin B4 | 63 | parts by mass |
| Ester wax A | 5 | parts by mass |
| Carbon black | 6 | parts by mass |
| Charge control agent (polysaccharide | 1 | part by mass |
| inclusion compound containing Al and Mg) | | |

A toner of Example 9 was produced as follows.

The toner of Example 9 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A1 | 15 | parts by mass |
| Amorphous polyester resin B1 | 63 | parts by mass |
| Ester wax B | 5 | parts by mass |
| Carbon black | 6 | parts by mass |
| Charge control agent (polysaccharide | 1 | part by mass |
| inclusion compound containing Al and Mg) | | |

A toner of Example 10 was produced as follows.

The toner of Example 10 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A1 | 15 | parts by mass |
| Amorphous polyester resin B1 | 63 | parts by mass |
| Ester wax C | 5 | parts by mass |
| Carbon black | 6 | parts by mass |
| Charge control agent (polysaccharide | 1 | part by mass |
| inclusion compound containing Al and Mg) | | |

A toner of Example 11 was produced as follows.

The toner of Example 11 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A1 | 15 | parts by mass |
| Amorphous polyester resin B1 | 63 | parts by mass |
| Ester wax D | 5 | parts by mass |
| Carbon black | 6 | parts by mass |
| Charge control agent (polysaccharide | 1 | part by mass |
| inclusion compound containing Al and Mg) | | |

A toner of Example 12 was produced as follows.

The toner of Example 12 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A1 | 15 | parts by mass |
| Amorphous polyester resin B1 | 63 | parts by mass |
| Ester wax E | 5 | parts by mass |
| Carbon black | 6 | parts by mass |
| Charge control agent (polysaccharide | 1 | part by mass |
| inclusion compound containing Al and Mg) | | |

A toner of Example 13 was produced as follows.

The toner of Example 13 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A1 | 15 | parts by mass |
| Amorphous polyester resin B1 | 63 | parts by mass |
| Ester wax F | 5 | parts by mass |
| Carbon black | 6 | parts by mass |
| Charge control agent (polysaccharide | 1 | part by mass |
| inclusion compound containing Al and Mg) | | |

A toner of Comparative Example 1 was produced as follows.

The toner of Comparative Example 1 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A6 | 15 | parts by mass |
| Amorphous polyester resin B2 | 63 | parts by mass |
| Ester wax A | 5 | parts by mass |
| Carbon black | 6 | parts by mass |
| Charge control agent (polysaccharide | 1 | part by mass |
| inclusion compound containing Al and Mg) | | |

A toner of Comparative Example 2 was produced as follows.

The toner of Comparative Example 2 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A7 | 15 | parts by mass |
| Amorphous polyester resin B3 | 63 | parts by mass |
| Ester wax A | 5 | parts by mass |
| Carbon black | 6 | parts by mass |
| Charge control agent (polysaccharide | 1 | part by mass |
| inclusion compound containing Al and Mg) | | |

A toner of Comparative Example 3 was produced as follows.

The toner of Comparative Example 3 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A3 | 15 | parts by mass |
| Amorphous polyester resin B5 | 63 | parts by mass |
| Ester wax A | 5 | parts by mass |
| Carbon black | 6 | parts by mass |
| Charge control agent (polysaccharide | 1 | part by mass |
| inclusion compound containing Al and Mg) | | |

A toner of Comparative Example 4 was produced as follows.

The toner of Comparative Example 4 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A4 | 15 | parts by mass |
| Amorphous polyester resin B6 | 63 | parts by mass |
| Ester wax A | 5 | parts by mass |
| Carbon black | 6 | parts by mass |
| Charge control agent (polysaccharide | 1 | part by mass |
| inclusion compound containing Al and Mg) | | |

A toner of Comparative Example 5 was produced as follows.

The toner of Comparative Example 5 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A8 | 15 | parts by mass |
| Amorphous polyester resin B7 | 63 | parts by mass |
| Ester wax A | 5 | parts by mass |
| Carbon black | 6 | parts by mass |
| Charge control agent (polysaccharide | 1 | part by mass |
| inclusion compound containing Al and Mg) | | |

A toner of Comparative Example 6 was produced as follows.

The toner of Comparative Example 6 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A9 | 15 | parts by mass |
| Amorphous polyester resin B8 | 63 | parts by mass |
| Ester wax A | 5 | parts by mass |
| Carbon black | 6 | parts by mass |
| Charge control agent (polysaccharide | 1 | part by mass |
| inclusion compound containing Al and Mg) | | |

A toner of Comparative Example 7 was produced as follows.

The toner of Comparative Example 7 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A1 | 15 | parts by mass |
| Amorphous polyester resin B1 | 63 | parts by mass |
| Ester wax G | 5 | parts by mass |
| Carbon black | 6 | parts by mass |
| Charge control agent (polysaccharide | 1 | part by mass |
| inclusion compound containing Al and Mg) | | |

A toner of Comparative Example 8 was produced as follows.

The toner of Comparative Example 8 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A1 | 15 | parts by mass |
| Amorphous polyester resin B1 | 63 | parts by mass |
| Ester wax H | 5 | parts by mass |
| Carbon black | 6 | parts by mass |
| Charge control agent (polysaccharide | 1 | part by mass |
| inclusion compound containing Al and Mg) | | |

A toner of Comparative Example 9 was produced as follows.

The toner of Comparative Example 9 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A1 | 15 | parts by mass |
| Amorphous polyester resin B1 | 63 | parts by mass |
| Ester wax I | 5 | parts by mass |
| Carbon black | 6 | parts by mass |
| Charge control agent (polysaccharide | 1 | part by mass |
| inclusion compound containing Al and Mg) | | |

A toner of Comparative Example 10 was produced as follows.

The toner of Comparative Example 10 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A1 | 15 | parts by mass |
| Amorphous polyester resin B1 | 63 | parts by mass |
| Ester wax J | 5 | parts by mass |
| Carbon black | 6 | parts by mass |
| Charge control agent (polysaccharide | 1 | part by mass |
| inclusion compound containing Al and Mg) | | |

A toner of Comparative Example 11 was produced as follows.

The toner of Comparative Example 11 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A1 | 15 | parts by mass |
| Amorphous polyester resin B1 | 63 | parts by mass |
| Ester wax K | 5 | parts by mass |
| Carbon black | 6 | parts by mass |
| Charge control agent (polysaccharide | 1 | part by mass |
| inclusion compound containing Al and Mg) | | |

A toner of Comparative Example 12 was produced as follows.

The toner of Comparative Example 12 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A1 | 15 | parts by mass |
| Amorphous polyester resin B1 | 63 | parts by mass |
| Ester wax L | 5 | parts by mass |
| Carbon black | 6 | parts by mass |
| Charge control agent (polysaccharide | 1 | part by mass |
| inclusion compound containing Al and Mg) | | |

A toner of Comparative Example 13 was produced as follows.

The toner of Comparative Example 13 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A1 | 15 | parts by mass |
| Amorphous polyester resin B1 | 63 | parts by mass |
| Ester wax M | 5 | parts by mass |
| Carbon black | 6 | parts by mass |
| Charge control agent (polysaccharide | 1 | part by mass |
| inclusion compound containing Al and Mg) | | |

A toner of Comparative Example 14 was produced as follows.

The toner of Comparative Example 14 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A1 | 15 | parts by mass |
| Amorphous polyester resin B1 | 63 | parts by mass |
| Ester wax N | 5 | parts by mass |
| Carbon black | 6 | parts by mass |
| Charge control agent (polysaccharide | 1 | part by mass |
| inclusion compound containing Al and Mg) | | |

A toner of Comparative Example 15 was produced as follows.

The toner of Comparative Example 15 was obtained in the same manner as in Example 1 except that the composition of the raw materials of the toner base particles was changed as follows.

| | | |
|---|---|---|
| Crystalline polyester resin | 10 | parts by mass |
| Amorphous polyester resin A1 | 15 | parts by mass |
| Amorphous polyester resin B1 | 63 | parts by mass |
| Ester wax O | 5 | parts by mass |
| Carbon black | 6 | parts by mass |
| Charge control agent (polysaccharide | 1 | part by mass |
| inclusion compound containing Al and Mg) | | |

A method for measuring the carbon number distribution of the ester compounds (the proportion of each of the ester compounds with the corresponding carbon number) constituting the ester wax is described.

0.5 g of each of the toners of the respective Examples was weighed and placed in an Erlenmeyer flask. Subsequently, 2 mL of methylene chloride was added to the Erlenmeyer flask to dissolve the toner. Further, 4 mL of hexane was added to the Erlenmeyer flask to form a mixed liquid. The mixed liquid was filtered and separated into a filtrate and an insoluble material. The solvent was distilled off from the filtrate under a nitrogen gas stream, whereby a deposited material was obtained. With respect to the deposited material, the carbon number distribution of the ester compounds in the ester wax extracted from the toner was measured.

The proportion of each of the ester compounds with the corresponding carbon number was measured using FD-MS “JMS-T100GC (manufactured by JEOL Ltd.)”. The measurement conditions are as follows.

Sample concentration: 1 mg/mL (solvent: chloroform)

Cathode voltage: -10 kv

Spectral recording interval: 0.4 s

Measurement mass range (m/z): between 10 and 2000

The total ionic strength of the ester compounds with the corresponding carbon number obtained by the measurement was assumed to be 100. The relative value of the ionic strength of each of the ester compounds with the corresponding carbon number with respect to the total ionic strength was determined. The relative value was defined as the proportion of each of the ester compounds with the corresponding carbon number in the ester wax. Further, the carbon number of the ester compound with a carbon number, the relative value of which is highest, was denoted by C₁.

A method for analyzing the first monomer group and the second monomer group will be described.

1 g of each ester wax was subjected to a methanolysis reaction under the conditions of a temperature of 70° C. for 3 hours. The product after the methanolysis reaction was subjected to mass spectrometry using FD-MS, and the content of each of the long-chain alkyl carboxylic acids with the corresponding carbon number and the content of each of the long-chain alkyl alcohols with the corresponding carbon number were determined.

A method for measuring the carbon number distribution of the carboxylic acids (the proportion of each of the carboxylic acids with the corresponding carbon number) constituting the first monomer group will be described.

The proportion of each of the carboxylic acids with the corresponding carbon number was measured using FD-MS “JMS-T100GC (manufactured by JEOL Ltd.)”. The measurement conditions are as follows.

Sample concentration: 1 mg/mL (solvent: chloroform)

Cathode voltage: -10 kv

Spectral recording interval: 0.4 s Measurement mass range (m/z): between 10 and 2000

The total ionic strength of the carboxylic acids with the corresponding carbon number obtained by the measurement was assumed to be 100. The relative value of the ionic strength of each of the carboxylic acids with the corresponding carbon number with respect to the total ionic strength was determined. The relative value was defined as the proportion of each of the carboxylic acids with the corresponding carbon number in the ester wax. Further, the carbon number of the carboxylic acid with a carbon number, the relative value of which is highest, was denoted by C.

A method for measuring the carbon number distribution of the alcohols (the proportion of each of the alcohols with the corresponding carbon number) constituting the second monomer group is described.

The proportion of each of the alcohols with the corresponding carbon number was measured using FD-MS “JMS-T100GC (manufactured by JEOL Ltd.)”. The measurement conditions are as follows.

Sample concentration: 1 mg/mL (solvent: chloroform)

Cathode voltage: -10 kv

Spectral recording interval: 0.4 s

Measurement mass range (m/z): between 10 and 2000

The total ionic strength of the alcohols with the corresponding carbon number obtained by the measurement was assumed to be 100. The relative value of the ionic strength of each of the alcohols with the corresponding carbon number with respect to the total ionic strength was determined. The relative value was defined as the proportion of each of the alcohols with the corresponding carbon number in the ester wax. Further, the carbon number of the alcohol with a carbon number, the relative value of which is highest, was denoted by Cₘ.

With respect to the ester waxes A to O, the carbon number C₁ of the ester compound, the content of which is highest, the carbon number Cₙ of the carboxylic acid, the content of which is highest in the first monomer group, the carbon number Cₘ of the alcohol, the content of which is highest in the second monomer group, and the melting point were as follows, respectively.
Ester wax A (C₁: 44, Cₙ: 23, Cₘ: 22, melting point: 70° C.)
Ester wax B (C₁: 44, Cₙ: 22, Cₘ: 22, melting point: 70° C.)
Ester wax C (C₁: 44, Cₙ: 20, Cₘ: 23, melting point: 71° C.)
Ester wax D (C₁: 44, Cₙ: 22, Cₘ: 21, melting point: 73° C.)
Ester wax E (C₁: 44, Cₙ: 22, Cₘ: 22, melting point: 72° C.)
Ester wax F (C₁: 44, Cₙ: 20, Cₘ: 23, melting point: 68° C.)
Ester wax G (C₁: 42, Cₙ: 19, Cₘ: 23, melting point: 66° C.)
Ester wax H (C₁: 42, Cₙ: 20, Cₘ: 20, melting point: 65° C.)
Ester wax I (C₁: 44, Cₙ: 22, Cₘ: 22, melting point: 70° C.)
Ester wax J (C₁: 44, Cₙ: 22, Cₘ: 22, melting point: 69° C.)
Ester wax K (C₁: 43, Cₙ: 21, Cₘ: 22, melting point: 70° C.)
Ester wax L (C₁: 43, Cₙ: 22, Cₘ: 21, melting point: 70° C.)
Ester wax M (C₁: 44, Cₙ: 24, Cₘ: 22, melting point: 74° C.)
Ester wax N (C₁: 44, Cₙ: 22, Cₘ: 23, melting point: 71° C.)
Ester wax O (C₁: 36, Cₙ: 18, Cₘ: 18, melting point: 60° C.) With respect to the ester waxes A to F, the carbon number distribution of the ester wax had only one maximum peak in a region where the carbon number is 43 or more. The ester waxes G, H, and O did not meet the condition that the carbon number distribution of the ester wax has only one maximum peak in a region where the carbon number is 43 or more. The properties of the ester waxes A to O obtained from the measurement results of mass distribution are shown in Table 1.

TABLE 1

| | a₁ | a₂ | b₁ | b₂ | c₁ | c₂ |
|---|---|---|---|---|---|---|
| Ester wax A | 3 | 3 | 3 | 15 | 80 | 80 |
| Ester wax B | 4 | 3 | 3 | 15 | 70 | 70 |
| Ester wax C | 3 | 3 | 2 | 15 | 95 | 70 |
| Ester wax D | 3 | 3 | 0 | 5 | 90 | 90 |
| Ester wax E | 3 | 4 | 0 | 5 | 90 | 90 |
| Ester wax F | 3 | 3 | 5 | 18 | 85 | 82 |
| Ester wax G | 3 | 3 | 8 | 15 | 80 | 80 |
| Ester wax H | 3 | 3 | 5 | 24 | 80 | 80 |
| Ester wax I | 2 | 3 | 5 | 15 | 80 | 80 |
| Ester wax J | 3 | 2 | 5 | 15 | 80 | 80 |
| Ester wax K | 3 | 3 | 3 | 15 | 65 | 80 |
| Ester wax L | 3 | 3 | 3 | 15 | 80 | 65 |
| Ester wax M | 3 | 3 | 3 | 15 | 100 | 90 |
| Ester wax N | 3 | 3 | 3 | 15 | 90 | 95 |
| Ester wax O | 1 | 1 | 100 | 100 | 100 | 100 |

In Table 1, a₁ is the number of types [types] of carboxylic acids in the first monomer group. a₂ is the number of types [types] of alcohols in the second monomer group. b₁ is the total proportion [mass %] of the carboxylic acids with a carbon number of 18 or less with respect to 100 mass % of the first monomer group. b₂ is the total proportion [mass %] of the alcohols with a carbon number of 18 or less with respect to 100 mass % of the second monomer group. c₁ is the proportion [mass %] of the carboxylic acid with a carbon number of Cₙ with respect to 100 mass % of the first monomer group. c₂ is the proportion [mass %] of the alcohol with a carbon number of Cₘ with respect to 100 mass % of the second monomer group.

Developers of respective Examples are described.

With respect to 100 parts by mass of ferrite carrier, 8.5 parts by mass of each of the toners of the respective Examples was stirred using a Turbula mixer, whereby developers of the respective Examples were obtained. The surface of the ferrite carrier is coated with a silicone resin having an average particle diameter of 40 μm.

A method for evaluating the fixability is described.

Each of the developers of the respective Examples was stored in a toner cartridge. The toner cartridge was placed in an image forming apparatus for evaluating the fixability. The image forming apparatus for evaluating the fixability is commercially available e-studio 5018A (manufactured by Toshiba Tec Corporation). By using the image forming apparatus, fixability was evaluated by confirming whether or not offset occurs while continuously copying a solid band image with an image density of 1.3 to 1.4 on 10 sheets of A4 size paper. Specifically, when offset did not occur in both the following high temperature and high humidity environment and low temperature and low humidity environment, the fixability of the toner was evaluated as pass (A). When offset occurred in at least either of the following high temperature and high humidity environment and low temperature and low humidity environment, the fixability of the toner was evaluated as fail (B).
High temperature and high humidity environment: The image forming apparatus was placed in a test environment at a temperature of 30° C. and a humidity of 85%. The voltage was set to 110 V, and A4 size paper with a basis weight of 105 g/m² was used.
Low temperature and low humidity environment: The image forming apparatus was placed in a test environment at a temperature of 10° C. and a humidity of 20%. The voltage was set to 90 V, and A4 size paper with a basis weight of 60 g/m² was used.

A method for evaluating the storage stability is described.

Each of the toners of the respective Examples was left at 55° C. for 8 hours. 20 g of each of the toners of the respective Examples after being left at 55° C. for 8 hours was sieved through a mesh with an opening of 350 μm, and the toner remaining on the mesh was weighed. As the amount of the toner remaining on the mesh is smaller, the storage stability is superior. When the amount of the toner remaining on the mesh was 3 g or less, the storage stability of the toner was evaluated as pass (A). When the amount of the toner remaining on the mesh was more than 3 g, the storage stability of the toner was evaluated as fail (B).

A method for evaluating the heat resistance is described.

Each of the developers of the respective Examples was stored in a toner cartridge. The toner cartridge was placed in an image forming apparatus for evaluating the heat resistance. The image forming apparatus for evaluating the heat resistance is commercially available e-studio 5018A (manufactured by Toshiba Tec Corporation). By using the image forming apparatus, an original document with a printing ratio of 4.0% was continuously copied on A4 size paper. Whether or not conveyance failure or a defective image occurred was confirmed every time the temperature in the developing device was raised by 2° C. while copying. When the temperature at which conveyance failure or a defective image started to occur was 45° C. or higher, the heat resistance of the toner was evaluated as pass (A). When the temperature at which conveyance failure or a defective image started to occur was lower than 45° C., the heat resistance of the toner was evaluated as fail (B).

A method for evaluating the filming suppression is described.

Each of the developers of the respective Examples was stored in a toner cartridge. The toner cartridge was placed in an image forming apparatus for evaluating the filming suppression. The image forming apparatus for evaluating the filming suppression is commercially available e-studio 5018A (manufactured by Toshiba Tec Corporation). The image forming apparatus was placed in a test environment at a temperature of 30° C. and a humidity of 85%. By using the image forming apparatus, an original document with a printing ratio of 8.0% was continuously copied on both sides of A4 size paper. Copying was continuously performed on 2,000 sheets, and a half-tone image was output every 200 sheets. Whether or not a streak occurred in the output half-tone image was determined by visual observation. When a streak did not occur in the half-tone image, filming suppression was evaluated as pass (A). When a streak occurred in the half-tone image, filming suppression was evaluated as fail (B).

The evaluation results of the fixability, storage stability, heat resistance, and filming suppression of the toners of the respective Examples are shown in Tables 2 and 3.

TABLE 2

| | | | | | Low- | | | |
|---|---|---|---|---|---|---|---|---|
| | T_{A} | T_{B} | T_{A} − T_{B} | Ester | temperature | Storage | Heat | Filming |
| | [° C.] | [° C.] | [° C.] | wax | fixability | stability | resistance | suppression |
| Example 1 | 132 | 103 | 29 | A | A | A | A | A |
| Example 2 | 141 | 103 | 38 | A | A | A | A | A |
| Example 3 | 125 | 95 | 30 | A | A | A | A | A |
| Example 4 | 150 | 120 | 30 | A | A | A | A | A |
| Example 5 | 150 | 105 | 45 | A | A | A | A | A |
| Example 6 | 125 | 105 | 20 | A | A | A | A | A |
| Example 7 | 140 | 95 | 45 | A | A | A | A | A |
| Example 8 | 125 | 105 | 20 | A | A | A | A | A |
| Example 9 | 132 | 103 | 29 | B | A | A | A | A |
| Example 10 | 132 | 103 | 29 | C | A | A | A | A |
| Example 11 | 132 | 103 | 29 | D | A | A | A | A |
| Example 12 | 132 | 103 | 29 | E | A | A | A | A |
| Example 13 | 132 | 103 | 29 | F | A | A | A | A |

TABLE 3

| | | | | | Low- | | | |
|---|---|---|---|---|---|---|---|---|
| | T_{A} | T_{B} | T_{A} − T_{B} | Ester | temperature | Storage | Heat | Filming |
| | [° C.] | [° C.] | [° C.] | wax | fixability | stability | resistance | suppression |
| Comparative | 121 | 95 | 26 | A | B | A | B | A |
| Example 1 | | | | | | | | |
| Comparative | 153 | 120 | 33 | A | B | A | A | B |
| Example 2 | | | | | | | | |
| Comparative | 125 | 92 | 33 | A | B | A | B | A |
| Example 3 | | | | | | | | |
| Comparative | 150 | 122 | 28 | A | B | A | A | A |
| Example 4 | | | | | | | | |
| Comparative | 128 | 110 | 18 | A | B | A | A | A |
| Example 5 | | | | | | | | |
| Comparative | 146 | 98 | 48 | A | A | B | A | B |
| Example 6 | | | | | | | | |
| Comparative | 132 | 103 | 29 | G | B | B | B | B |
| Example 7 | | | | | | | | |
| Comparative | 132 | 103 | 29 | H | B | B | B | B |
| Example 8 | | | | | | | | |
| Comparative | 132 | 103 | 29 | I | A | B | B | B |
| Example 9 | | | | | | | | |
| Comparative | 132 | 103 | 29 | J | A | B | B | B |
| Example 10 | | | | | | | | |
| Comparative | 132 | 103 | 29 | K | B | A | A | A |
| Example 11 | | | | | | | | |
| Comparative | 132 | 103 | 29 | L | B | A | A | A |
| Example 12 | | | | | | | | |
| Comparative | 132 | 103 | 29 | M | A | B | B | B |
| Example 13 | | | | | | | | |
| Comparative | 132 | 103 | 29 | N | A | B | B | B |
| Example 14 | | | | | | | | |
| Comparative | 132 | 103 | 29 | O | B | B | B | B |
| Example 15 | | | | | | | | |

In Tables 2 and 3, T_{A} is the softening point of the amorphous polyester resin A. T_{B} is the softening point of the amorphous polyester resin B. T_{A}-T_{B} is a difference between the softening point of the amorphous polyester resin A and the softening point of the amorphous polyester resin B.

The toners of Examples 1 to 13 had excellent heat resistance, storage stability, fixability, and filming suppression.

On the other hand, the toners of Comparative Examples 1 to 15 did not simultaneously meet the pass criteria for all the heat resistance, storage stability, fixability, and filming suppression.

While certain embodiments of the invention have been described, these embodiments have been presented by way of example only, and are not intended to limit the scope of the invention. The embodiments described herein may be embodied in various other forms, and various omissions, substitutions, and changes may be made without departing from the gist of the invention. The embodiments and modifications thereof are included in the scope and gist of the invention and also included in the invention described in the claims and in the scope of their equivalents.

What is claimed is:

1. A toner comprising:
an amorphous polyester resin A having a softening point of 125 to 150° C.;
an amorphous polyester resin B having a softening point of 95 to 120° C.;
a crystalline polyester resin; and
an ester wax, wherein
the ester wax is a condensation polymer of a first monomer group comprising at least three or more types of carboxylic acids and a second monomer group comprising at least three or more types of alcohols,
the proportion of a carboxylic acid with a carbon number of Cₙ, the content of which is highest in the first monomer group, is between 70 and 95 mass % with respect to 100 mass % of the first monomer group,
the proportion of a carboxylic acid with a carbon number of 18 or less in the first monomer group is 5 mass % or less with respect to 100 mass % of the first monomer group,
the proportion of an alcohol with a carbon number of Cₘ, the content of which is highest in the second monomer group, is between 70 and 90 mass % with respect to 100 mass % of the second monomer group,
the proportion of an alcohol with a carbon number of 18 or less in the second monomer group is 20 mass % or less with respect to 100 mass % of the second monomer group, and
a difference between the softening point of the amorphous polyester resin A and the softening point of the amorphous polyester resin B is between 20 and 45° C.

2. The toner according to claim 1, wherein the amorphous polyester resin A has a softening point of 125 to 140° C.

3. The toner according to claim 1, wherein amorphous polyester resin B has a softening point of 98 to 115° C.

4. The toner according to claim 1, wherein crystalline polyester resin has a melting point of 60 and 120° C.

5. The toner according to claim 1, wherein carbon number Cₙ is between 19 and 28.

6. The toner according to claim 1, wherein carbon number Cₘ is between 19 and 28.

7. The toner according to claim 1, wherein the ester wax comprises an ester compound with a carbon number between 43 and 56.

8. The toner according to claim 1, wherein the ester wax has a melting point is between 60 and 85° C.

9. The toner according to claim 1, wherein the amorphous polyester resin A is present in an amount between 5 and 40 mass % with respect to the 100 mass % of the toner base particles.

10. The toner according to claim 1, wherein the amorphous polyester resin B is present in an amount between 40 and 70 mass % with respect to the 100 mass % of the toner base particles.

11. The toner according to claim 1, wherein the ratio of the content of the amorphous polyester resin B to the content of the amorphous polyester resin A is between 1/9 and 5/5.

12. The toner according to claim 1, wherein the crystalline polyester resin is present in an amount between 5 and 20 mass % with respect to 100 mass % of the toner base particles.

13. The toner according to claim 1, wherein the ester wax is present in an amount between 3 and 15 mass % with respect to 100 mass % of the toner base particles.

14. The toner according to claim 1, wherein the difference between the softening point of the amorphous polyester resin A and the softening point of the amorphous polyester resin B is between 20 and 35° C.

15. The toner according to claim 1, wherein a difference between the softening point of the amorphous polyester resin A and the melting point of the ester wax is between 40 and 90° C.

16. The toner according to claim 1, further comprising a colorant, a charge control agent, a surfactant, a basic compound, an aggregating agent, a pH adjusting agent, an antioxidant, or any combination thereof.

17. A toner cartridge comprising a container comprising the toner according to claim 1.

18. An image forming apparatus comprising the toner cartridge according to claim 17.
